(19) United States
(12) Patent Application Publication
(10) Pub. No.: US 2002/0075134 A1
(43) Pub. Date: Jun. 20, 2002

(54) Intelligent signal switch/detector

(76) Inventors: Pieter Schieke, Phoenix, AZ (US); Steven Dawson, Scottsdale, AZ (US)

Correspondence Address: PAUL N. KATZ, BAKER BOTTS L.L.P., ONE SHELL PLAZA, 901 LOUISIANA STREET, HOUSTON, TX, 77002-4995, US

(21) Appl. No.: 09/740,713

(22) Filed: Dec. 19, 2000

(51) Int. Cl. H04Q 5/22

(52) U.S. Cl. 340/10.4; 340/572.4

(57) ABSTRACT

An intelligent signal switch/detector is used in a wireless transponder device fabricated in an integrated circuit package so that dc offset bias need not be a factor in determining the no signal logic level to an input of a digital microcontroller. Direct current components from the transponder receiver amplifier are ignored and only the received alternating current signal information is passed on to a logic circuit to be processed. The intelligent signal switch/detector comprises a circuit such as a monostable which is triggered by a rising edge from an output of the transponder receiver amplifier. The edge triggered circuit then generates a pulse(s) that is input to the logic circuit. The width of the pulse may be adjusted for different applications. The intelligent signal switch/detector enables optimum sensitivity in the receive circuits without concern for any ambiguity in the logic level polarity to the logic circuit due to variations in the dc biasing of the high gain amplifier of the wireless transponder receiver.

### FIELD OF THE INVENTION

This invention relates generally to wireless transponders, and more particularly, to an intelligent signal switch/detector that recognizes only alternating current (AC) signals while ignoring inherent circuit direct current (DC) offset of any polarity.

### BACKGROUND OF THE INVENTION TECHNOLOGY

Wireless transponders may be used in managing inventory, automatic identification of cars on toll roads, building entry, security systems, keyless electronic access and entry devices, and the like. Wireless transponders may comprise an electromagnetic, radio frequency and/or infrared receiver and transmitter and thereby communicate with a related base station by either first receiving a coded signal and then responding back with a coded transmitted signal, or transmitting a coded signal first then waiting for the correct response to be returned from the related base station. Any combination of coded signal “handshakes” may be utilized by a transponder and a base station in trying to identify a “friend” or “foe.” Once a friendly coded signal is identified and verified a desired action may be taken, i.e., unlocking a car door, opening a garage door, or building access or egress.

An example of a transponder-base station system is the KEELOQ® (a registered trademark of Microchip Technology Inc.) Code Hopping Encoder and Transponder, part number HCS412 by Microchip Technology Inc., more fully described in Specification DS41099A (1999), available at http://www.microchip.com, and incorporated by reference herein.

An introduction to passive radio frequency identification (RFID) devices is described in Microchip application note AN680 (1998), and RFID system design guides for 125 kHz and 13.56 MHz are available at http://www.microchip.com, and all are incorporated by reference herein.

Typically, the base station amplitude modulates a CW RF carrier of an RF generator, an electromagnetic field generator, or an infrared transmitter with a data word bitstream in accordance with the binary values of that data word bitstream. The data word bitstream is a series of on/off pulses which represent, for example, a serial data word synchronization header, a tag number, etc. These series of on/off pulses are received by the related transponder. Range is limited, however, by the transmitted signal power and the sensitivity of the receiving transponder. Usually, the transmitted signal is restricted to very low power so the only way to increase operating range is to increase the received signal level sensitivity of the receiving transponder.

A high gain analog amplifier will greatly increase the receiver sensitivity of the transponder. The high gain analog amplifier which makes possible the required receiver sensitivity may also suffer from process variations that can cause an ambiguous output state when no signal is being received. This is due to input offset errors that unpredictably cause the amplifier output to be either at a logic “1” (at Vdd) or at a logic “0” (ground or Vss) when there is no signal present. This output ambiguity creates a problem when interfacing the output of the transponder receiver “front end” amplifier to other digital logic circuits such as a microcontroller of the transponder.

Therefore, what is needed is a method, apparatus and system that will produce a definite output state when no signal is being received, regardless of any variation in the dc offset and resulting no signal output state of the high gain receiving amplifier.

### SUMMARY OF THE INVENTION

The invention overcomes the above-identified problems as well as other shortcomings and deficiencies of existing technologies by providing an intelligent signal switch/detector that ignores any dc logic level at its input and only passes an ac signal component, i.e., transitions between logic levels while maintaining a defined output logic level when no ac signal is present.

In accordance with the embodiments of the present invention, the intelligent signal switch/detector is connected between the output of a high gain signal amplifier and a logic circuit for decoding the signal information. The input of the high gain amplifier is coupled to an antenna which is adapted for receiving the radio frequency and/or electromagnetic signals from a transmitting base unit. The antenna is typically an inductor and capacitor connected in a parallel circuit, resonating at a desired operating frequency. The logic circuit may be any type of digital circuit capable of doing the necessary synchronization, decoding, etc., e.g., a microcontroller, microprocessor, digital signal processor (DSP), programmable logic array (PLA) and field programmable gate array (FPGA). The logic circuits may also be adapted for secure communications such as the KEELOQ products of Microchip Technology Inc., which are incorporated by reference herein for all purposes.

The present invention may be fabricated in an integrated circuit package having the receiver amplifier, intelligent signal switch/detector and logic circuit(s). An advantage of the present invention is that no special dc input offset bias trimming or adjustment need be performed during testing or manufacture of the high gain amplifier since its output voltage level when there is no input signal present is now irrelevant.

The transponders may typically receive at signal frequencies from about 100 kHz to about 14 MHz, and may transmit from about 100 kHz to well into the ultra high frequency (UHF) range for RF and electromagnetic applications. The optical infrared transponders use infrared wavelengths for operation thereof. Signals that are transmitted in different types of energy forms and frequencies may be intercepted by an appropriate signal sensor such as a radio frequency antenna, IR detector, magnetic field pick-up coil, Hall device, ultrasonic sensor, etc.

The intelligent signal switch/detector of the present invention may comprise a time delay circuit or an edge triggered monostable having a pulse width time constant that is less than the time of a cycle of the desired received signal frequency when used as an intelligent switch. When used as an intelligent amplitude detector, a retriggerable monostable having a pulse width greater than the time period of a cycle of the received signal frequency may be used. The monostable will only actuate upon detecting a logic level transition, i.e., logic 0 to logic 1 or logic 1 to logic 0. For all other steady state signal input conditions the monostable output will not actuate (no input logic level change-no monostable output pulse). The intelligent signal switch/detector of the present invention always has a defined logic level state when no signal is present. Only when a signal being received produces a changing logic level will the intelligent signal switch/detector pass the changing signal component, not any dc offset or undefined output logic level at a no signal condition.

Features and advantages of the invention will be apparent from the following description of the embodiments, given for the purpose of disclosure and taken in conjunction with the accompanying drawings.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a schematic block diagram of an exemplary embodiment of the invention as used in a transponder system;

FIG. 2 is a schematic diagram of an exemplary embodiment of an intelligent switch according to the present invention;

FIG. 3 illustrates exemplary timing diagram waveforms of the circuit, illustrated in FIG. 2, receiving a first quiescent input logic level;

FIG. 4 illustrates exemplary timing diagram waveforms of the circuit, illustrated in FIG. 2, receiving a second quiescent input logic level;

FIG. 5 is a schematic diagram of an exemplary embodiment of an intelligent detector according to the present invention; and

FIG. 6 illustrates exemplary timing diagram waveforms of the circuit of FIG. 5.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to an intelligent signal switch/detector used with a wireless transponder-base station system, such as for example but not limited to, radio frequency, electromagnetic and infrared. The transponder may be fabricated in an integrated circuit package and connected (external to the package) to a parallel connected inductor-capacitor resonant tuned circuit used for an antenna. For infrared (IR) applications an IR detector may be utilized for reception of the transmitted IR signals. The present invention is especially useful in any application requiring not only secure communication of data and commands but also the protection of any valuable asset or property. For example but not limitation: (1) Vehicular applications comprising remote keyless entry, alarm systems, and immobilizers for cars and trucks. (2) Consumer and commercial applications comprising car alarms, garage door openers, burglar alarms, gate locks, door locks, and communications for smoke, carbon monoxide and radon detectors. (3) Industrial applications comprising package tracking, parts tracking, package and equipment tags, and identity tokens. The present invention enables hands-free operation of locks, doors, gates and the like. Since the transponder is able to receive a low power radio frequency signal, verification and activation of the lock of a door or gate opening mechanism may occur from a distance and without having to remove the transponder system from ones pocket, purse, or briefcase. Commonly owned related patent applications are U.S. patent application Ser. No. 09/405,451, entitled “An Integrated Circuit Device Having a Self-Biased, Single Pin Radio Frequency Signal Input” by Willem Smit, Pieter Schieke and Willem J. Mameweck; U.S. patent application Ser. No. 09/432,907, entitled “Passive Signal Discriminator for Wake-Up of Low Power Transponder” by Willem J. Marneweck and Johannes Albertus van Niekerk; U.S. patent application Ser. No. 09/217,691, entitled “High Gain Input for a Radio Frequency Identification (RFID) Transponder and Method Therefor” by Willem Smit and Pieter Schieke; and U.S. Pat. No. 5,998,980, entitled “Highly Efficient Multi-Frequency Voltage Regulating Circuit Incorporating a Magnetic Field Power Sensor and Programmable Magnetic Field Detection” by Schieke et al., all hereby being incorporated by reference herein for all purposes.

Referring now to the drawings, the details of exemplary embodiments of the invention are schematically illustrated. Like elements in the drawings will be represented by like numbers, and similar elements will be represented by like numbers with a different lower case letter suffix.

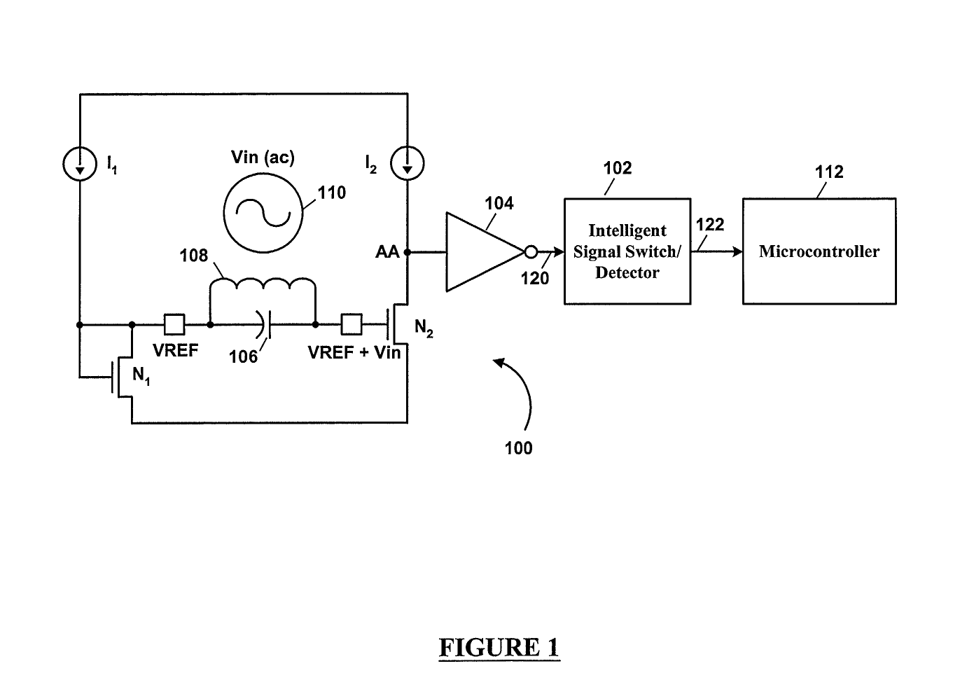

Referring now to FIG. 1, a schematic block diagram of an embodiment of the invention, is illustrated. According to an embodiment of the present invention, a remote keyless entry (RKE) or passive keyless entry (PKE) transponder comprises a front end high gain signal amplifier generally represented by the numeral 100. A high gain signal amplifier 100 comprises input transistors N₁, and N₂, current sources I₁ and I₂ and a high gain inverting amplifier 104. The high gain signal amplifier 100 is used as a sensitive front end for a data signal receiver of the RKE/PKE transponder.

A parallel tuned circuit used as an antenna comprises a capacitor 106 and an inductor 108 connected to the signal input transistor N₂ and biasing transistor N₁, (nodes VREF+Vin and VREF, respectively). The amplification of the amplifier 100 may be optimized to receive low level signals, thus enabling a good useable range for the transponder system.

The parallel tuned circuit is adapted to receive electromagnetic or radio frequency (RF) energy from a signal source 110. The received energy is in the form of an alternating current (AC) signal which is coupled to and amplified by the amplifier 100. The amplified signal from the output of the amplifier 120 is then detected (demodulated) as information for processing in logic circuits such as a microcontroller 112.

An infrared detector (not illustrated) may be used in place of the parallel tuned circuit antenna (capacitor 106 and inductor 108) for reception of IR signals from a IR transmitting base station.

It is contemplated and within the scope of the present invention that multiple signal inputs may be obtained with multiple antennas (or IR detectors) and front end amplifiers (not illustrated) having common outputs connected to the input 122 of the intelligent signal switch/detector 102.

A problem exists, however, in that the output of the high gain amplifier 100 (output of the inverting amplifier 104) may be either at a logic 0 or at a logic 1 when no input signal is present. In a normal situation, I₁=I₂, N₂<N₁, and the threshold voltage, V_{THN2}, of N₂ is greater than V_{REF}. This results in the amplifier 104 having an output at a definite logic 0. When there is a device mismatch, V_{THN2}<V_{REF}, this causes the output of the amplifier 104 to be at a logic 1 during no signal conditions. Without special setup and adjustment during testing or circuit fabrication, the exact output characteristics of the high gain amplifier are unknown and may fall within either case. A problem the present invention overcomes is that it makes no difference what the logic level is of the amplifier 104 output at quiescent no signal conditions, only when a desired signal is being received does the intelligent signal switch/detector 102 pass the received signal information from a known quiescent no signal logic level at the output 122 of the intelligent signal switch/detector 102.

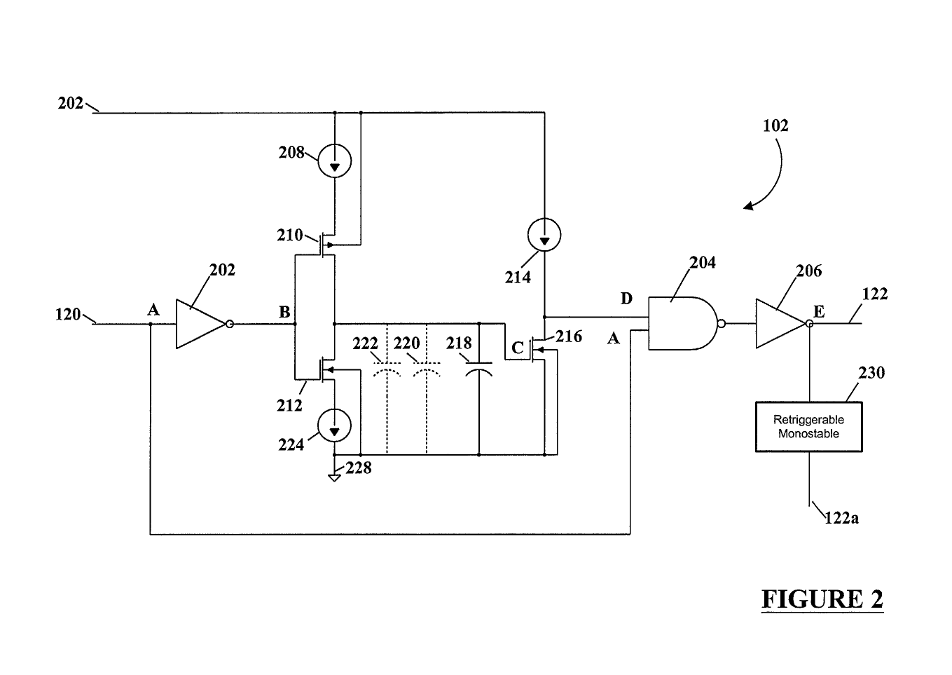

Referring now to FIG. 2, a schematic diagram of an embodiment of the intelligent switch 102 is illustrated. The intelligent switch 102 comprises an inverter 202, NAND gate 204, inverter 206, transistors 210, 212 and 216; current sources 208, 214 and 224, and capacitor 218. Capacitors 220 and 220 may be added during manufacture, testing or they may be switched in and out with an analog switch (not illustrated) controlled, for example, by the microcontroller 112. Power supply voltage, V_{DD} is applied at node 202, power supply common, and V_{SS}, at node 228. Transistors 210 and 212 form an inverter that is current limited by the current sources 208 and 224. Transistor 216 and current source 214 form an inverter having a weak pull-up to V_{DD}.

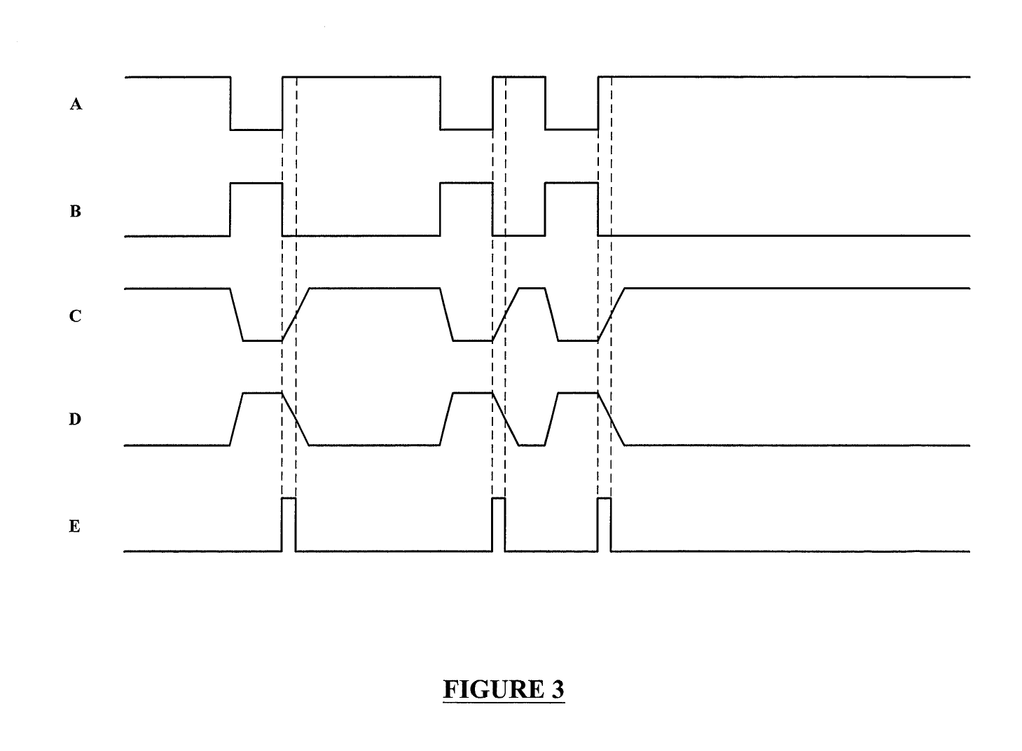

Referring to FIG. 3, timing diagram waveforms of the circuit of FIG. 2 receiving a first quiescent input logic level is illustrated. The waveforms of FIG. 3 represent those signal logic levels at the corresponding nodes illustrated in the schematic of FIG. 2. When the quiescent no signal logic level from the output of the amplifier 104 is at a logic 1 (mismatched undesired input condition), the logic level at the input node 120 of the intelligent signal switch 102 is also at a logic level 1. In this instance, the inverter 202 has a logic 0 output at node B. Node B being at logic 0 cuts off the transistor 212 and allows current to flow through current source 208 and transistor 210, thereby charge the capacitor 218. During a no signal condition as described above, the capacitor 218 will remain fully charged until the transistor 212 turns on to discharge the capacitor 218 in a controlled discharge through current source 224.

When the capacitor 218 is charged, node C is at a logic 1 and the output of the transistor 216 is at logic 0, pulling node D to logic 0 and thereby forcing node E to logic 0. Having node E at logic 0 during no signal conditions is what is desired and a feature of the invention. As soon as the signal logic level changes from the inverter 104 at the input 120 (node A) to a logic 0, node B goes to a logic 1, turning on transistor 212 which then causes the voltage on the capacitor 218 to discharge through the current source 224. At a certain point, the voltage on the capacitor can no longer maintain the node C voltage sufficient to retain the transistor 216 on, i.e., node D must go to a logic 1 through the weak pull-up of the current source 214. As soon as node A returns to a logic 1 (a signal pulse has been detected) the capacitor 218 begins charging again. However, since there is a time delay in the discharging and charging of the capacitor 218, there will be an overlap when both of the nodes A and D are at a logic 1. When this occurs, node E briefly outputs a logic 1 pulse. This represents a desired signal cycle being received. So long as the time constant of the monostable formed with the capacitor 218 (220 and 222, etc.) and the current sources are less than a cycle time of the received signal every cycle of the received signal will be represented as a pulse at the node E.

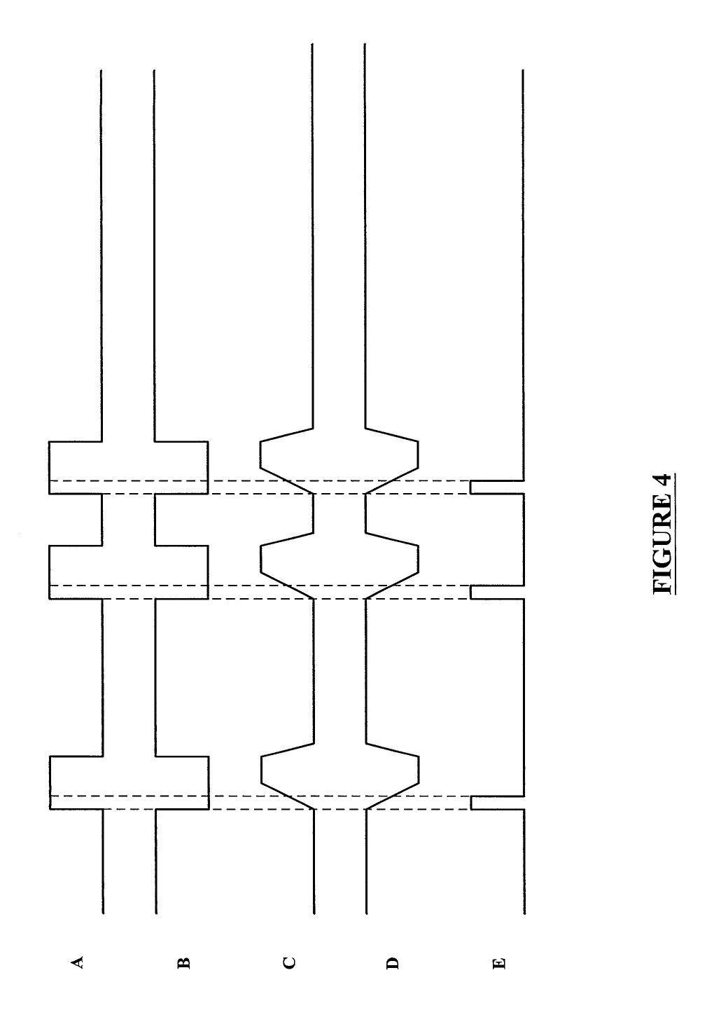

Referring now to FIG. 4, timing diagram waveforms of the circuit of FIG. 2 receiving a second quiescent input logic level is illustrated. The waveforms of FIG. 4 represent those signal logic levels at the corresponding nodes illustrated in the schematic of FIG. 2. When the quiescent no signal logic level from the output of the amplifier 104 is at a logic 0 (desired input condition), the logic level at the input node 120 of the intelligent signal switch 102 is also at a logic level 0. In this instance, the inverter 202 has a logic 1 output at node B. Node B being at logic 1 turns on the transistor 212 and thereby keeps the capacitor 218 discharged. During a no signal condition as described above, the capacitor 218 will remain discharged until the transistor 212 turns off so that the transistor 210 and current source 212 can charge the capacitor 218.

When the capacitor 218 is discharged, node C is at logic 0 and the output of the transistor 216 (node C) is at logic 1. During this time node A is at logic 0, thereby forcing node E to logic 0. Having node E at logic 0 during no signal conditions is what is desired and a feature of the invention. As soon as the inverter 104 output (node A) signal logic level changes from a logic 0 to a logic 1, node B goes to a logic 0 which causes the current source 208 and transistor 210 to begin charging the capacitor 218. However, this takes time and node D remains at logic 1 until the voltage being charged on the capacitor 218 at node C turns on the transistor 216, then node D goes to a logic 0. However, during this time both nodes A and D are at logic 1, thereby causing a logic 1 pulse to occur. This represents a desired signal cycle being received. So long as the time constant of the monostable formed with the capacitor 218 (220 and 222, etc.) and the current source are less than a cycle time of the received signal every cycle of the received signal will be represented as a pulse at the node E.

A retriggerable monostable 230 may be connected between the output 122 and the microcontroller 112. The monostable 230 is adapted to have a pulse output time of slightly greater than one cycle of the received signal and may thus be used to demodulate the amplitude modulated signal into a information pulse suitable for directly inputting to the decoding logic circuits (microcontroller 112). An amplitude detector such as a rectifier and low pass filter (not illustrated) may also be used to demodulate the amplitude information on the carrier signal, ready for decoding in the logic circuits. The decoding logic circuits may also be a digital signal processor (DSP).

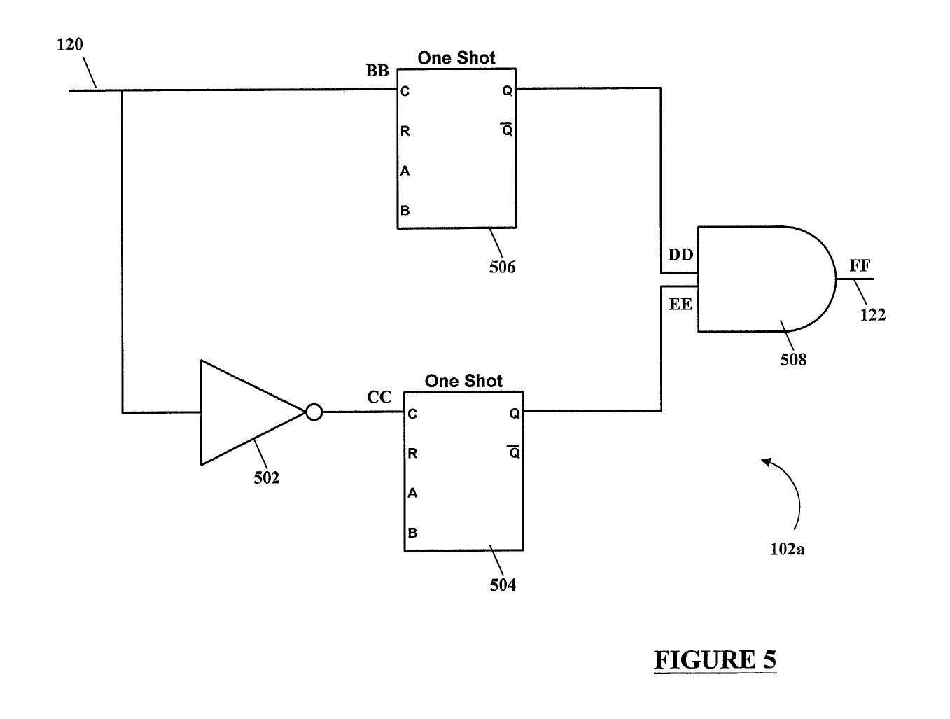

Referring now to FIG. 5, a schematic diagram of an intelligent signal detector embodiment of the invention is illustrated. The intelligent signal detector is generally represented by the numeral 102a and comprises an inverter 502, a first monostable 504, a second monostable 506, and an AND gate 508 (or a NAND and a inverter). The monostables 504 and 508 are adapted to have retriggerable output pulses of a time duration slightly greater than a cycle time of the received signal from the high gain receiver amplifier 100. The monostables 504 will trigger when an input thereto goes from logic 0 to logic 1, i.e., positive edge triggered. It is contemplated and within the scope of the present invention that negative edge triggered (going from logic 1 to a logic 0) will also work equally well.

During quiescent no signal input conditions, the input 120 may be at either logic 1 or logic 0, as described herein. The monostables 504 and 506 generally will have timed out since no input logic level transitions are occurring. Thus the Q outputs of the monostables 504 and 506 are both at logic 0 and the output of the AND gate 508 is also at logic 0, the desired no signal condition for output 122 (node FF).

When a signal is received and the output of the inverter 104 goes from logic 0 to logic 1 (desired condition), monostable 506 causes a logic 1 pulse at the Q output, node DD, to be generated for a time duration slightly longer than a cycle of the signal frequency being received. On the other hand, when the signal is received and the output of the inverter 104 goes from logic 1 to logic 0 (undesired condition), the inverter 502 triggers the monostable 504 to cause a logic 1 pulse at its Q output, node EE, to be generated for a time duration slightly longer than a cycle of the signal frequency being received.

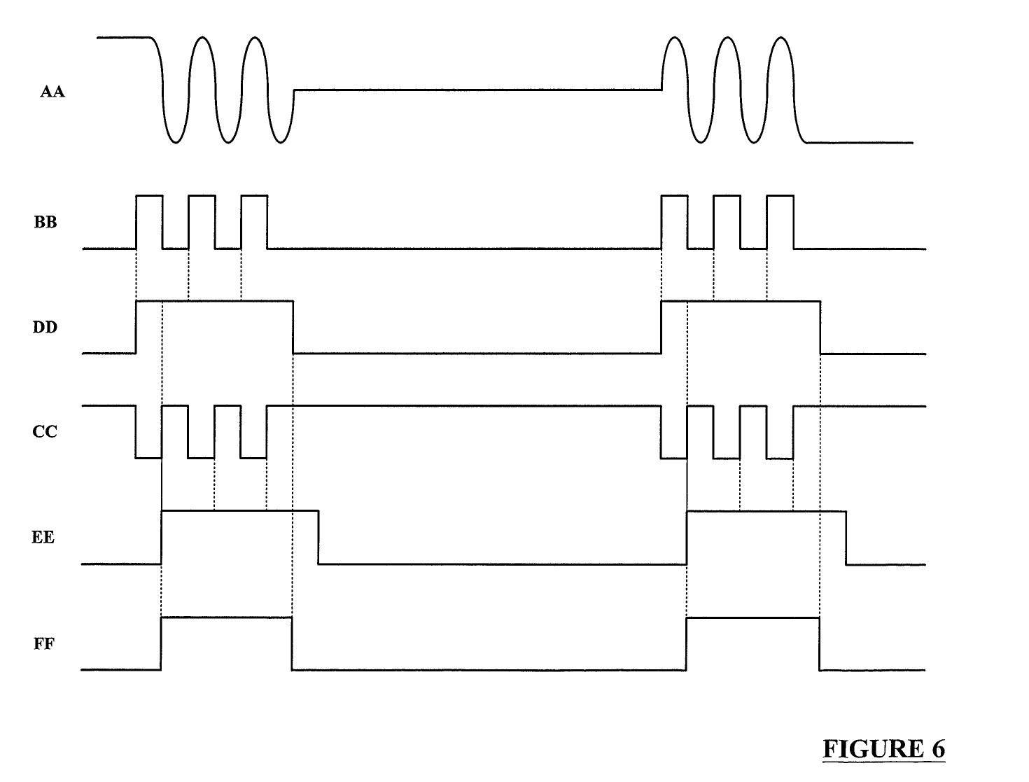

Referring now to FIG. 6, a timing diagram of the circuit of FIG. 5 is illustrated. The timing diagram waveforms and relationships help give a better understanding of both the quiescent signal output and detection features of the intelligent signal detector of FIG. 5. Waveform AA schematically represents the received signal at node AA illustrated in FIG. 1 (showing a logic 1 no signal state at the very left and a logic 0 no signal state at the very right of the diagram). This is a substantially sinusoidal radio frequency or electromagnetic signal that is either present or not present, signal presence or lack thereof are each for a specific duration of time. The waveform BB represents logic level changes corresponding to each positive period of the sinusoidal waveform AA. Waveform BB is applied at the input 120, node BB, which triggers the monostable 506 each time a positive edge (logic 0 to logic 1 ) occurs. Since the monostable 506 output pulse is slightly longer that a cycle of the sinusoidal waveform AA, the Q output of the monostable 506 remains at a logic 1 so long as there are positive edged pulses at node BB.

The inverter 502 produces the waveform CC at node CC which is the input to monostable 504. Whenever a negative edge occurs on the waveform BB (thereby inverted to a positive edge at node CC by the inverter 502) the monostable 504 will generate an output pulse at node EE. Whenever there is a negative edge pulse at node BB, the monostable 504 will generate an output pulse at node EE. This output pulse is also slightly longer that a cycle of the sinusoidal waveform AA, therefore the Q output of the monostable 504 remains at a logic 1 so long as there are continuous negative edge pulses at node BB.

When receiving a signal, and thereby recreating pulses at node BB, both monostables 506 and 504 will have logic 1 outputs at nodes DD and EE, respectively.

Node FF will be at logic 1 whenever nodes DD and EE are both at logic 1, thus the waveform FF illustrated in FIG. 6 is obtained at the output 122. This is thereby a correct logic level polarity amplitude detected signal that is ready for processing in the microcontroller 112. Both the intelligent signal switch and the intelligent signal detector embodiments described herein are readily adapted for connecting directly to digital logic circuits such as a microcontroller, microprocessor, digital signal processor, etc., and having a known output at a first logic level when there is no signal present and at a second logic level with a signal is being received. The intelligent signal switch/detector operating independently of any dc offset bias particularities of the front end amplification circuits.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A transponder, comprising:
a signal sensor;
an amplifier having an input connected to said signal sensor, wherein said amplifier is adapted for amplifying a signal from said signal sensor;
a signal switch connected to said amplifier output, said signal switch adapted to generate a pulse each time the output of said amplifier goes from a first logic level to a second logic level, wherein said signal switch output remains at a defined logic level when there is no change in logic levels at the output of said amplifier; and
a logic circuit connected to the output of said signal switch.

2. The transponder of claim 1, wherein said signal sensor is a tuned circuit antenna comprising an inductor and a capacitor.

3. The transponder of claim 2, wherein said inductor and capacitor are connected in parallel.

4. The transponder of claim 1, wherein the signal is a radio frequency wave and said signal sensor is a radio frequency sensor.

5. The transponder of claim 1, wherein the signal is an infrared light wave and said signal sensor is an infrared sensor.

6. The transponder of claim 1, wherein the signal is an electromagnetic wave and said signal sensor is an electromagnetic sensor.

7. The transponder of claim 1, wherein the signal is an acoustic wave and said signal sensor is an acoustic sensor.

8. The transponder of claim 1, wherein the first logic level is at logic 0 and the second logic level is at logic 1.

9. The transponder of claim 1, wherein the first logic level is at logic 1 and the second logic level is at logic 0.

10. The transponder of claim 1, wherein the signal switch pulse time duration is less than a cycle of the received signal frequency.

11. The transponder of claim 1, wherein the signal switch pulse time duration is greater than a cycle of the received signal frequency.

12. The transponder of claim 1, wherein said signal switch comprises an edge triggered monostable for generating the pulse.

13. The transponder of claim 1, wherein said logic circuit is adapted for secure communications.

14. The transponder of claim 1, wherein said logic circuit is selected from the group consisting of microcontroller, a digital signal processor, a microprocessor, a programmable logic array and a field programmable gate array.

15. The transponder of claim 1, wherein the signal detector includes at least one edge triggered monostable for generating the pulse.

16. The transponder of claim 1, wherein the output of said amplifier goes from the first logic level to the second logic level for each cycle of the signal.

17. The transponder of claim 16, further comprising a retriggerable monostable connected between said signal switch and said logic circuit.

18. The transponder of claim 17, wherein said retriggerable monostable has an output pulse having a time duration longer than a cycle of the signal.

19. The transponder of claim 18, wherein said retriggerable monostable demodulates amplitude information consisting of groups of pulses from said signal switch.

20. The transponder of claim 16, further comprising an amplitude detector connected between said signal switch and said logic circuit, wherein said amplitude detector demodulates amplitude information consisting of groups of pulses from said signal switch.

21. The transponder of claim 20, wherein said amplitude detector comprises a rectifier and a low pass filter.

22. A transponder, comprising:
a signal sensor;
an amplifier having an input connected to said signal sensor, wherein said amplifier is adapted for amplifying a signal from said signal sensor;
a signal detector connected to said amplifier output, said signal detector adapted to demodulate amplitude information consisting of groups of pulses from the output of said amplifier when each pulse in the groups of pulses goes from a first logic level to a second logic level, wherein said signal detector output remains at a defined logic level when there is no change in logic levels at the output of said amplifier; and
a logic circuit connected to the output of said signal detector.

23. A signal switch having a defined output logic level at no signal conditions, comprising:
an AND gate having a first input connected to a signal input;
an inverter having an input connected to the signal input; and
a time delay circuit having an input connected to an output of the inverter an output connected to a second input of the AND gate, wherein when a signal on the signal input goes from a first logic level to a second logic level a pulse is generated from an output of the AND gate and when there is no change in logic levels on the signal input the AND gate output remains at a defined logic level.

24. A signal switch having a defined output logic level at no signal conditions, comprising:
a first monostable having a trigger input connected to a signal input;
an inverter having an input connected to the signal input;
a second monostable having a trigger input connected to an output of the inverter; and
an AND gate having a first input connected to an output of the first monostable and a second input connected to an output of the second monostable, wherein when a signal on the signal input goes from a first logic level to a second logic level a pulse is generated from an output of the AND gate and when there is no change in logic levels on the signal input the AND gate output remains at a defined logic level.

25. A signal detector having a defined output logic level at no signal conditions, comprising:
a first monostable having a trigger input connected to a signal input;
an inverter having an input connected to the signal input;
a second monostable having a trigger input connected to an output of the inverter; and
an AND gate having a first input connected to an output of the first monostable and a second input connected to an output of the second monostable,
wherein amplitude information is demodulated from groups of pulses going from a first logic level to a second logic level at the signal input, and the AND gate output remains at a defined logic level when there is no change in logic levels at the signal input.
